(19) United States
(12) Patent Application Publication
(10) Pub. No.: US 2008/0111989 A1
(43) Pub. Date: May 15, 2008

(54) TRANSPARENT MATERIAL INSPECTION SYSTEM

(76) Inventors: Christian Dufour, Montreal (CA); Jean-Robert Cote, Longueuil (CA)

Correspondence Address: BROUILLETTE & PARTNERS, METCALFE TOWER, 1550 METCALFE STREET, SUITE 800, MONTREAL, QC, H3A-1X6, omitted

(21) Appl. No.: 11/565,030

(22) Filed: Nov. 30, 2006

(30) Foreign Application Priority Data
Nov. 15, 2006 (CA) 2,568,260

(51) Int. Cl. G01B 9/00

(52) U.S. Cl. 356/124

(57) ABSTRACT

A system for the inspection of the optical quality of a part, object or product having a portion comprising transparent material such as ophthalmologic lenses, protective eyewear, visors, eyewear shield and the like is provided. A liquid crystal display (LCD) screen emits variable patterns of light through the transparent part under inspection to a charged coupled device (CCD) camera that captures the image and transmits the image data to an image processing module. The processed image data are then transmitted to an analysis module which then generally measures the dimensions of the part, the transparency, the colour and the optical strength. The analysis module also advantageously detects and measures the presence of dots, stains, scratches, optical distortions, fingerprints, cloudiness and other optical artefacts and/or defects in the transparent material. Accordingly, the patterns emitted by the LCD screen are designed to measure the optical specifications and highlight potential optical defects.

### CROSS-REFERENCE TO RELATED APPLICATIONS

There are no cross-related applications.

### FIELD OF THE INVENTION

This invention relates systems and apparatuses for the inspection of transparent materials such as, but not limited to, lens, eyewear, visors and eyewear shields. More particularly, the present invention relates to systems and apparatuses for the inspection of transparent materials which use charged coupled device (CCD) or similar cameras.

### BACKGROUND OF THE INVENTION

The testing of transparent material, such as contact lenses and eyewear, for optical properties, quality, colour, flaws and defects has previously been mainly performed by human inspectors who had to manually verify each object. Such a technique is generally prone to human error, lacks uniformity, and furthermore, is particularly tedious. Indeed, the quality of consecutive inspections can vary according to the degree of tiredness of the inspector.

Thus, in order to mitigate the lack of uniformity of transparent material inspection, some automated systems have been developed over the years for inspecting transparent materials.

Yet, since the objects which were usually most tested were ophthalmologic or contact lenses, the automated inspection systems which have been proposed over the years were generally specifically designed for such lenses. For example, Lafferty et al. (U.S. Pat. Nos. 5,801,822 and 5,818,573) proposed a system for inspecting ophthalmic lenses using either light emitting diodes (LED) or optical fibers and light diffuser. The defects in the lenses were detected via a CCD camera located on the other side of the lenses. The system of Lafferty et al. could also be provided with multiple light sources and hence, multiple cameras.

More recently, another lenses inspection system was proposed by Nishikawa (U.S. Pat. No. 6,373,578). In this system, which is particularly designed for inspecting lenses used in recording device (e.g. compact disk writer), the lens is inspected via a laser and an interferometer. Understandably, the system is quite limited to specific types of lenses.

A more general system for the detection of transparent and/or light diverting defects in transparent material was proposed by Weiss et al. (U.S. Pat. No. 6,633,377). The system of Weiss et al. uses dark views to detect to presence of light diverting defects.

Yet, even though all these systems are generally useful for their intended purposes, they are all generally limited in their applications. First, they are generally adapted for specific types of objects such as ophthalmic lenses which prevents the use of the same equipment for inspecting other types of transparent material. Moreover, prior art inspecting systems are generally not adapted to measure optical properties while also detecting flaws and defects. Finally, prior art inspecting systems generally use monochromatic light. Hence, defects which are generally non apparent when viewed in monochromatic light cannot be detected.

There is thus a need for a novel transparent material inspection system which generally obviates to aforementioned drawbacks.

### SUMMARY OF THE INVENTION

In accordance with the present invention, there is provided a novel system for the inspection of transparent materials such as, but not limited to, contact lenses, protective glasses, display glass panels, eyewear shields, visors, etc.

Generally speaking, the inspection system of the present invention comprises a liquid crystal display (LCD) or similar screen which emits variable and preferably preprogrammed patterns of light through the transparent part under inspection. The image of the pattern through the inspected transparent part is then captured by a charged coupled device (CCD) or similar camera. The camera then transmits the data to an image processing module which then transmits the processed image to an analysis module. The latter generally measures, when applicable, the dimensions of the part, its transparency, its colour and its optical strength. Understandably, depending on the capabilities of the analysis module, other optical properties could also be determined and/or measured. The analysis module also advantageously detects the presence of dots, stains, scratches, optical distortions, fingerprints, cloudiness and other optical artefacts and/or defects in the transparent material. The patterns emitted by the LCD screen are preferably designed to measure the optical specifications and also to highlight potential defects.

Accordingly, the present invention preferably comprises a LCD connected to a LCD panel driver. Still, other systems to display images could also be used if found to work adequately in the context of the present invention. Accordingly, the expression LCD must not be narrowly construed and should be interpreted as encompassing other similar display systems having generally similar capabilities.

The system further comprises a CCD camera which is connected to an image processing module. As for the LCD, the CCD camera should not be narrowly construed and should be interpreted as encompassing other image capturing systems having generally similar capabilities.

The LCD panel driver and the image processing module are further connected together via a computer system which is preferably provided with a user interface for generally allowing a human operator to monitor the inspection process. Yet, the LCD and the CCD are preferably located inside a dark room or enclosure, substantially sealed from exterior light, in order to prevent such exterior light to interfere with the inspection process.

In order to inspect an object comprising a portion made of transparent material, the object is placed between the LCD and the CCD in order for the camera to be able to capture the image of the pattern projected by the LCD after its passage through the transparent material. The image captured by the CCD is then sent to the image processing module for image processing and then to an analysis module for further optical properties analysis and defect analysis.

Depending on the level of inspection needed for particular objects, the analysis module is generally adapted to measure at least certain optical properties of the transparent material. For example, in the case of a lens, the analysis module would generally be adapted to measure its dimensions, its transparency and its optical strength. Furthermore, in the particular case of tinted lens (e.g. sunglass lens), the analysis module would also be preferably able to measure the colour of the lens. Yet, in the case of glass panels used, for example, in the manufacture of cathode ray tube (CRT) monitors and LCD screens, the optical properties analysis of the analysis module could be limited to fewer optical characteristics.

Advantageously, the optical properties to be determined and/or measured could be chosen by a human operator via the user interface. Also, preprogrammed optical properties analyses for specific objects could be stored on the computer system. These preprogrammed analyses could be loaded prior to the inspection of certain objects. The present inspection system is therefore able to inspect transparent objects and materials of different size and shape.

Still, an important aspect of the present system is the detection of defects in the transparent material. Indeed, in order for the inspection system to be able to detect different types of defects, the LCD, via the LCD panel driver and the computer system, is able to project different light patterns, each of which can be used to highlight particular defects. Preferably and to speed up the inspection process, the patterns are generally and preferably preprogrammed and projected in a consecutive manner. Still, it could be possible to manually select certain patterns via the user interface in order, for example, to inspect more closely certain defects. Moreover, it is also possible to create new or custom patterns and to load them into the computer system.

The inspection system, according to the present invention, will generally detect scratches, dots, bubbles, fingerprints, distortion, stains and other similar defects.

Accordingly, the system of the present invention generally works by projecting a first pattern which image through the transparent material is captured by the CCD and processed and analysed by the image processing module and by the analysis module respectively. Then a second pattern is projected and its image through the transparent material is captured by the CCD and similarly processed and analysed by the image processing module and the analysis module. The process continues as long as there are patterns to be displayed. In a possible alternative embodiment, the projection of patterns could be stopped by the detection of a major and generally fatal defect.

According to an aspect of the present invention, the inspection system is provided with a coordinates calibration procedure. The object of this procedure is generally to match the pixel coordinates of the LCD with the sensor coordinates of the CCD.

Also, according to an important aspect of the present invention, the inspection system is also provided with an intensity calibration procedure. This procedure calibrates the intensity of each pixel of the LCD so that the captured image of the LCD on the CCD is of uniform intensity. Since the position of each pixel on the LCD must generally be precisely known in order to correctly adjust its intensity, this second calibration procedure is generally executed after the coordinates calibration procedure. These calibration procedures are generally iterative in nature.

By calibrating the intensity of the pixels of the LCD prior to the inspection procedure, the present invention is generally able to detect more defects since the image effectively captured by the CCD is substantially not biased by variation in the intensity of the pixels of the LCD.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawing in which:

FIG. 1 is a schematic view of an embodiment of the inspection system of the present invention.

### DETAILED DESCRIPTION OF THE PREFERRED EMBODIMENT

A novel system for inspecting transparent material will be described hereinafter. Although the invention is described in terms of specific illustrative embodiments, it is to be understood that the embodiments described herein are by way of example only and that the scope of the invention is not intended to be limited thereby.

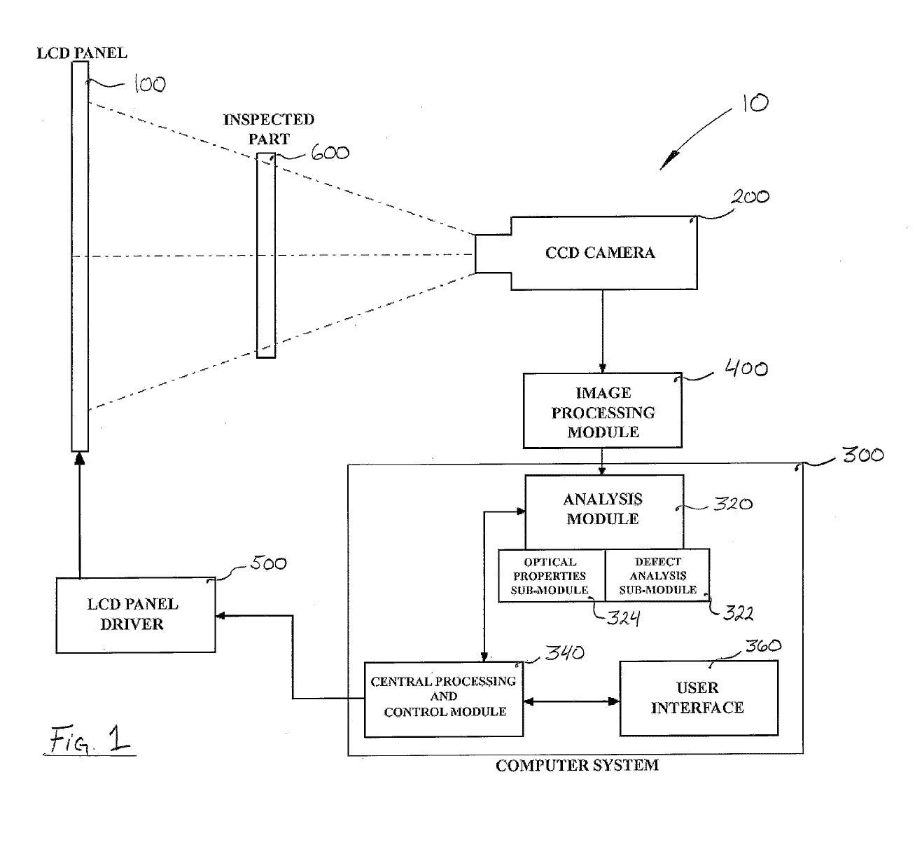

Referring now to FIG. 1, the inspection system 10 of the present invention generally comprises a LCD panel 100 and a CCD camera 200 facing the LCD. The alignment between the LCD 100 and the CCD 200 can be chosen and changed as required according to any type of inspection.

The LCD panel 100 is in electronic communication, with wire or wirelessly, with a LCD panel driver 500. Understandably, the LCD panel driver 500 controls the LCD panel 100 and the images projected thereby. Preferably, the LCD panel driver 500 is able to control the intensity of each individual pixel forming the LCD panel 100.

The CCD camera 200 is in electronic communication, with wire or wirelessly, with an image processing module 400. The image processing module 400 generally comprises all the hardware such as processors and storage devices and the softwares such as databases and image processing softwares to adequately process, store and/or retrieve the images captured by the CCD 200. The image processing module 400 could also be provided with additional hardware and/or additional softwares if necessary.

In order to close the loop, the image processing module 400 and the LCD panel driver 500 are further connected together via a computer system 300. Understandably, the connection therebetween could be with wire or wireless.

As can be seen from FIG. 1, the computer system 300 itself comprises several modules. First, the computer system 300 comprises a central processing and control module 340 which is in electronic communication with the LCD panel driver 500. The computer system 300 also comprises an analysis module 320, itself comprising a defect analysis sub-module 322 and an optical properties analysis sub-module 324. The analysis module 320 is electronically connected with the image processing module 400. Finally, the computer system 300 preferably comprises a user interface 360, generally in the form a display screen coupled with input means such as a keyboard (not shown) and/or a pointer device (not shown). Other user interface could also be used.

As shown in FIG. 1, the analysis module 320 and the user interface 360 are generally connected to the central processing and control module 340.

Though not shown for clarity, it is to be understood that the LCD 100 and the CCD 200 are preferably mounted inside a dark room or enclosure to prevent exterior light from interfering with the inspection procedure.

Prior to inspecting transparent material, the system 10 of the present invention is preferably calibrated in order to adjust the coordinates system between the LCD 100 and the CCD 200 and also to adjust the intensity of the LCD 100 with respect to the receptivity of the CCD 200. Such calibration procedures shall be further described hereinbelow. In any case, the system 10 of the present invention is not limited to any particular calibration methods.

In use, an object, part or product, comprising a portion made of transparent material 600 to be inspected, is placed between the LCD 100 and the CCD 200. Then, the LCD 100, driven by the computer system 300 via the LCD panel driver 500, projects a series of preferably preprogrammed light patterns through the transparent material 600, the images of which are then captured by the CCD 200. The captured images are then processed by the image processing module 400 and then preferably sent to the analysis module 320 of the computer system 300 for further analyses.

Depending on the type of inspection required, when the captured images are in the analysis module 320, they can be analysed for defect detection by the defect analysis sub-module 322 and/or they can be analysed for optical properties determination and measurement by the optical properties analysis sub-module 324.

As the captured images of the projected patterns are analysed, an indication of the progress of the inspection process can be displayed on the user interface 360. At the end of the inspection process, a report can be advantageously displayed on the user interface 360. Such a report would preferably contain the relevant information concerning the measured optical properties and the detected defects if any.

Understandably, should the object, part or product comprising transparent material 600 to be inspected be curved and/or of large size, the system 10 of the present invention could be provided with multiple LCD 100 and correspondingly multiple CCD 200 to fully cover the object, part or product.

One of the main advantages of the present invention is the ability of the LCD 100 to project patterns of different types and configurations, each pattern being generally adapted to highlight certain defects or to measure particular optical properties. However, in order to fully use the capacity of the LCD 100, the inspection system 10 of the present invention and more particularly its computer system 300, is provided with methods or procedures to calibrate the coordinates and the intensity of the pixels of the LCD with respect to the images captured by the CCD.

First, concerning the coordinates, to precisely inspect transparent material, the position and orientation of the patterns projected by the LCD 100 must be precisely known. Also, unless a telecentric lens is used on the CCD camera 200, which is not always possible due to the size of the inspected parts, the projected patterns will generally be at least slightly deformed. Therefore, the coordinates calibration procedure is used to enable the projection of the patterns at the desired coordinates and to modify their shape to compensate the deformation due to the lens of the CCD 200.

Therefore, prior to inspecting transparent material 600, the system 10 preferably calibrates the coordinates of the pixels of the LCD 100 with the coordinates of the CCD 200. In one exemplary though not limitative version of the procedure, the computer system 300 instructs the LCD 100, via the LCD panel driver 500, to project a pattern of rows and columns of dots. These dots have known positions. Then the image of this pattern is captured by the CCD 200 and processed by the image processing module 400. The processed image is then sent to the computer system 300 in order for the computer system 300 to determine the positions of the dots on the captured image of the pattern. The computer system 300 then compares the positions of the projected dots with the measured positions of the dots on the captured image of the pattern and then computes the difference therebetween. Using the aforementioned computed difference, the computer system generates a modified pattern which is then projected by the LCD 100 and captured by the CCD 200. The process recited above is then repeated iteratively until the expected positions of the projected dots and their measured positions are the same.

According to the preferred embodiment, this calibration of the coordinates is generally crucial to the next calibration, the intensity calibration.

As it is generally known in the art, LCD panels are composed of a plurality of pixels, each of which is capable of producing the range of colour for which the LCD was designed. Yet, despite quality control in the manufacturing process, it remains possible that two pixels located on the same LCD and equally electrically excited produce the same colour but with a slight difference in intensity. Moreover, the intensity of the pixels can change over time as the LCD becomes older. Finally, and more importantly, the angle from which a pixel is viewed will affect the perceived intensity thereof.

On the CCD 200 side, it is generally known that lens located therein may affect the captured intensity of certain pixels of the LCD.

Thus, for example, even though it might not be visible to the naked eye, it is fairly possible that a completely white LCD screen may not effectively be of equal intensity and/or that the captured image of a completely white LCD screen may not be seen as being evenly white and/or as having an even intensity.

Thus, to equalise what is effectively captured and perceived by the CCD 200, and which is effectively processed and analysed, the computer system 300 preferably calibrates the LCD 100 prior to inspecting transparent material 600.

In one exemplary manner, the computer system 300 instructs the LCD 100, via the LCD panel driver 500, to project a pattern of even intensity. The pattern is then captured by the CCD 200 and processed by the image processing module 400 prior to being sent to the computer system 300. The computer system 300 then compares the intensity of the pixels of the captured image of the pattern with the intensity of the pixels of the pattern effectively projected. The computer system 300 then computes and applies a multiplicative matrix to the projected pattern to compensate for the difference between the projected intensity and the captured one. The corrected pattern is then projected by the LCD 100 and the image is captured by the CCD 200. The captured image of the corrected pattern is then processed by the image processing module 400 and sent to the computed system for comparison with the projected pattern. The foregoing process is then repeated until the image captured by the CCD 200 is of even intensity.

It is to be understood that in order to compensate the right pixels, their position must be precisely known and that generally explains why the coordinates calibration is generally required prior to the intensity calibration. Moreover, the skilled addressee will understand that the pattern projected at the end of the intensity calibration may be of uneven intensity. However, the CCD 200 perceives this uneven intensity as even.

It is also to be understood that the calibration procedures described above are executed without the present of transparent material 600 between the LCD 100 and the CCD 200.

Once the calibrations are done, the inspection of transparent material 600 can begin. Still, in order to maintain the quality of the inspection, the inspection system 10 may be recalibrated as often as required.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A system for the inspection of transparent material, said system comprising:
a. a first electronic display device adapted to project patterns of light;
b. a first electronic image capturing device adapted to capture images;
c. processing means in electronic communication with said first electronic display device and said first electronic image capturing device;
wherein said processing means is adapted to generate and transmit output signals to said first electronic display device for said display device to display at least one of said patterns of light thereon, wherein said first electronic image capturing device is adapted to capture an image of said at least one pattern of light and to convert said image into input signals and wherein said processing means is adapted to receive and process said input signals from the first electronic image capturing device.

2. A system as claimed in claim 1, wherein said first electronic display device is a liquid crystal display (LCD) screen.

3. A system as claimed in claim 1, wherein said electronic image capturing device is a charged coupled device (CCD) camera.

4. A system as claimed in claim 1, wherein said processing means further comprises a first analysis module which is adapted to analyse said input signals in order to determine the presence of defects in said transparent material.

5. A system as claimed in claim 1, wherein said processing means further comprises a first analysis module which is adapted to analyse said input signals in order to determine optical properties of said transparent material.

6. A system as claimed in claim 4, wherein said processing means further comprises a second analysis module which is adapted to analyse said input signals in order to determine optical properties of said transparent material.

7. A system as claimed in claim 1, wherein at least one of said patterns of light is adapted to highlight at least one type of defect in said transparent material.

8. A system as claimed in claim 1, wherein at least one of said patterns of light is adapted to highlight at least one optical property of said transparent material.

9. A method to inspect transparent material using an inspection system comprising an electronic display device, an electronic image capturing device and processing means, said method comprising the steps of:
a. projecting a pattern of light, with said electronic display device, through said transparent material;
b. capturing an image of said pattern of light with said image capturing device;
c. processing said image of said pattern of light with said processing means;
d. analysing said processed image for determining optical properties of said transparent material and/or analysing said processed image for detecting defect in said transparent material.

10. A method as claimed in claim 9, wherein steps a., b., c. and d. are repeated for a plurality of different patterns of light.

11. A method to calibrate an inspection system comprising an electronic display device comprising a plurality of picture elements, an electronic image capturing device comprising a plurality of sensor elements and processing means, said method comprising the steps of:
a. projecting a pattern of light with said electronic display device, said pattern of light comprising specific illuminated picture elements having predetermined positions;
b. capturing an image of said pattern of light with said image capturing device;
c. measuring the positions of said illuminated picture elements on said sensor elements of said image capturing device with said processing means;
d. determining the differences between said predetermined positions and said measured positions of said illuminated picture elements with said processing means;
e. generating a correcting matrix based on said differences with said processing means;
f. applying said matrix to said pattern of light;
g. repeating steps a. to f. until said differences are null.

12. A method to calibrate an inspection system comprising an electronic display device comprising a plurality of picture elements, an electronic image capturing device and processing means, said method comprising the steps of:
a. projecting a pattern of light with said electronic display device wherein each of said picture elements has a specific intensity;
b. capturing an image of said pattern of light with said image capturing device;
c. measuring said intensity of said picture elements in said captured image of said pattern of light;
d. determining the differences between said intensity of said picture elements in said pattern of light and said intensity of said picture elements in said captured image;
e. generating a correcting matrix based on said differences with said processing means;
f. applying said matrix to said pattern of light;
g. repeating steps a. to f. until said differences are null.
